(19) United States
(12) Patent Application Publication
(10) Pub. No.: US 2024/0341353 A1
(43) Pub. Date: Oct. 17, 2024

(54) A CONSUMABLE FOR USE WITH A NON-COMBUSTIBLE AEROSOL PROVISION DEVICE

(71) Applicant: Nicoventures Trading Limited, London (GB)

(72) Inventors: John RICHARDSON, London (GB); Andrew BRAY, London (GB)

(21) Appl. No.: 18/294,771

(22) PCT Filed: Aug. 4, 2022
(86) PCT No.: PCT/EP2022/072015

§ 371 Date: Feb. 2, 2024

(30) Foreign Application Priority Data
Aug. 4, 2021 (GB) 2111265.1

(51) Int. Cl. A24F 40/20; A24B 15/167; A24C 5/01; A24D 1/02; A24D 1/20; A24F 40/465; H05B 6/10

(52) U.S. Cl. CPC A24F 40/20; A24B 15/167; A24C 5/01; A24D 1/02; A24D 1/20; A24F 40/465; H05B 6/108

(57) ABSTRACT

The present invention relates to a consumable for use with a non-combustible aerosol provision device; a non-combustible aerosol provision system comprising a non-combustible aerosol provision device and the consumable; and a kit comprising a non-combustible aerosol provision device and the consumable. The consumable comprises a support, aerosol generating material, and a protection element wherein; the aerosol generating material is at least partially supported on at least one surface of the support; the support comprises at least one surface and at least one fixing zone; the or each fixing zone is located on one or more surface of the support; the area extending between the outermost edges of the or each fixing zone includes at least a portion of the aerosol generating material; and the protection element is affixed to at least one fixing zone.

### TECHNICAL FIELD

The present invention relates to a consumable for use with a non-combustible aerosol provision device.

### BACKGROUND

Smoking articles such as cigarettes, cigars and the like burn tobacco during use to create tobacco smoke. Alternatives to these types of articles release an inhalable aerosol or vapour by releasing compounds from a substrate material by heating without burning. These may be referred to as non-combustible smoking articles or aerosol generating assemblies.

One example of such a product is a heating device which release compounds by heating, but not burning, a solid aerosol-generating material. This solid aerosol-generating material may, in some cases, contain a tobacco material. The heating volatilises at least one component of the material, typically forming an inhalable aerosol. These products may be referred to as heat-not-burn devices, tobacco heating devices or tobacco heating products. Various different arrangements for volatilising at least one component of the solid aerosol-generating material are known. Certain examples of these products utilise a consumable article which is brought into contact with the heating device. The consumable may contain the aerosol-generating material.

As another example, there are hybrid devices. These hybrid devices contain a liquid source (which may or may not contain nicotine) which is vaporised by heating to produce an inhalable vapour or aerosol. The device additionally contains a solid aerosol-generating material (which may or may not contain a tobacco material) and components of this material are entrained in the inhalable vapour or aerosol to produce the inhaled medium.

### SUMMARY

In accordance with some embodiments described herein, there is provided a consumable for use with a non-combustible aerosol provision device (e.g. an apparatus for heating aerosol generating material to volatilise at least one component of the aerosol generating material), the consumable comprising a support, aerosol generating material, and a protection element wherein;
the aerosol generating material is at least partially supported on a surface of the support;
the support comprises at least one surface and at least one fixing zone;
the or each fixing zone is located on one or more surface of the support;
the area extending between the outermost edges of the or each fixing zone includes at least a portion of the aerosol generating material; and
the protection element is affixed to at least one fixing zone.

In one embodiment the aerosol generating material comprises two or more discrete portions of aerosol generating material.

In an exemplary embodiment, the protection element may be a removable or partially removable protection element, such as a removable or partially removable sheet. This allows for effective protection of the portions of aerosol generating material while facilitating use of the consumable by removal of the protection element. Where the protection element is partially removable this may avoid generation of additional separate waste elements by the protection element remaining fixed to the consumable in at least one fixing zone.

In another exemplary embodiment, the protection element may be pierceable, such as a pierceable sheet or layer. This allows for effective protection of the portions of aerosol generating material while facilitating use of the consumable without generating additional waste. Where the protection element is pierceable such piercing may take place separately for each discrete portion of aerosol generating material, may take place for all portions essentially simultaneously or may take place for any subset of the portions comprised in the consumable. An appropriate piercing tool may be formed as part of the consumable, the consumable packaging and/or the heating device.

In a further exemplary embodiment, the consumable may comprise a susceptor formed, for example, from a sheet of material such as a metal foil. This allows for heating of at least one region of the consumable by means of electrical induction.

In accordance with some embodiments described herein, there is provided a consumable for use with a non-combustible aerosol provision device, wherein the aerosol generating material does not adhere or releasably adheres to the protection element.

In accordance with some embodiments described herein, there is provided a non-combustible aerosol provision system comprising a non-combustible aerosol provision device; and a consumable for use with the non-combustible aerosol provision device, the consumable comprising a support, aerosol generating material, and a protection element wherein;
the aerosol generating material optionally comprises two or more discrete portions of aerosol generating material;
the aerosol generating material is at least partially supported on at least one surface of the support;
the support comprises at least one surface and at least one fixing zone;
the or each fixing zone is located on one or more surface of the support;
the area extending between the outermost edges of the or each fixing zone includes at least a portion of the aerosol generating material; and
the protection element is affixed to at least one fixing zone.

In one embodiment the consumable comprises a susceptor. In an alternative embodiment the non-combustible aerosol provision device comprises a susceptor.

In accordance with some embodiments described herein, there is provided a kit comprising a non-combustible aerosol provision device; and a consumable for use with the a non-combustible aerosol provision device, the consumable comprising a support, aerosol generating material, and a protection element wherein;
the aerosol generating material optionally comprises two or more discrete portions of aerosol generating material;
the aerosol generating material is at least partially supported on at least one surface of the support;
the support comprises at least one surface and at least one fixing zone;
the or each fixing zone is located on one or more surface of the support;
the area extending between the outermost edges of the or each fixing zone includes at least a portion of the aerosol generating material; and
the protection element is affixed to at least one fixing zone.

In accordance with some embodiments described herein, there is provided a method of manufacturing a consumable for use with a non-combustible aerosol provision device, the method comprising providing a support having at least one surface and at least one fixing zone, providing an aerosol generating material on at least one surface of said support and affixing a protection element to the at least one fixing zone such that the area extending between the outmost edges of the or each fixing zone includes at least a portion of the aerosol generating material.

### BRIEF DESCRIPTION OF THE DRAWINGS

Embodiments of the invention will now be described, by way of example only, with reference to the accompanying drawings, in which:

FIG. 1 shows a schematic perspective view of a consumable for use with a non-combustible aerosol provision device with the protection element removed for use;

FIG. 2 shows a schematic perspective view of the consumable of FIG. 1 with the protection element in place;

FIG. 3 shows a schematic perspective view of an alternative consumable for use with a non-combustible aerosol provision device having the protection element in place and an alternative arrangement of fixing zones;

FIG. 4 shows a schematic perspective view of a set of consumables of FIG. 1 wherein, when placed together, each consumable acts as protection element for the consumable below.

FIG. 5 shows a schematic perspective view of an alternative consumable for use with a non-combustible aerosol provision device wherein the support comprises a support layer and a backing layer.

FIG. 6 shows a schematic perspective view of the consumable of FIG. 5 having two fixing zones such that the protection element is partially removable, being removable from zone 202 and substantially non-removable from zone 302.

FIG. 7 shows a schematic view of an alternative formation of consumable having a tubular support element and a protection element in the form of a ribbon wrapped around the consumable.

FIG. 8 shows a schematic view of a tubular consumable having protective elements in the form of one or more sheets. The consumable is shown with the protective element partially removed.

### DETAILED DESCRIPTION

The present disclosure relates to a consumable for use with a non-combustible aerosol provision device wherein the consumable has various features, which may include some of those described herein.

Such a consumable may allow for easier handling and/or use of the consumable and/or better hygiene due to protection of the aerosol generating material by means of the protection element. Such a consumable may further allow for easier packing, storage and/or use of the consumable since multiple consumables may be arranged in contact with other such consumables without the aerosol generating material becoming undesirably adhered to any part of any other consumable or any packaging material which may be present.

As used herein, the term “aerosol generating material” includes agents that provide volatilised components upon heating. “Aerosol generating material” includes any botanical-containing material and may, for example, include one or more of tobacco, tobacco derivatives including tobacco extracts, expanded tobacco, reconstituted tobacco or tobacco substitutes. “Aerosol generating material” may also include other, non-botanical (e.g, non-tobacco), products, including for example flavourants, which, depending on the product, may or may not contain nicotine, filler materials such as chalk and/or sorbent materials, glycerol, propylene glycol or triacetin. The aerosol generating material may also include a binding material, which may be a gelling material, for example, sodium alginate. The aerosol generating material may include tobacco consumables or leaves in solid form within the agent. In one example the aerosol generating material is an aerosol generating gel. The aerosol generating gel may be a solid, jelly like material. The aerosol generating gel may be a newtonian or non-newtonian gel.

The aerosol-generating material may comprise or be in the form of an aerosol-generating film. The aerosol-generating film may comprise a binder, such as a gelling agent, and an aerosol former. Optionally, a substance to be delivered and/or filler may also be present. The aerosol-generating film may be substantially free from botanical material. In particular, in some embodiments, the aerosol-generating material is substantially tobacco free.

The aerosol-generating film may have a thickness of about 0.015 mm to about 1 mm. For example, the thickness may be in the range of about 0.05 mm, 0.1 mm or 0.15 mm to about 0.5 mm or 0.3 mm.

The aerosol-generating film may be continuous. For example, the film may comprise or be a continuous film of material supported on a support.

The aerosol-generating film may be discontinuous. For example, the aerosol-generating film may comprise one or more discrete portions or regions of aerosol-generating material, such as dots, stripes or lines, which may be supported on a support.

In such embodiments, the support is planar or non-planar.

The aerosol-generating film may be formed by combining a binder, such as a gelling agent, with a solvent, such as water, an aerosol-former and one or more other components, such as one or more substances to be delivered, to form a slurry and then heating the slurry to volatilise at least some of the solvent to form the aerosol-generating film.

The slurry may be heated to remove at least about 60 wt %, 70 wt %, 80 wt %, 85 wt % or 90 wt % of the solvent.

The aerosol-generating material may comprise or be an “amorphous solid”. In some embodiments, the aerosol-generating material comprises an aerosol-generating film that is an amorphous solid. The amorphous solid may be a “monolithic solid”. The amorphous solid may be substantially non-fibrous. In some embodiments, the amorphous solid may be a dried gel. The amorphous solid is a solid material that may retain some fluid, such as liquid, within it. In some embodiments, the amorphous solid may, for example, comprise from about 0 wt %, 5 wt % or 10 wt % of liquid, to about 30 wt %, 40 wt % or 50 wt % of liquid.

The amorphous solid may be substantially free from botanical material. The amorphous solid may be substantially tobacco free.

Typical gelling agents which may be used in forming certain gel embodiments of aerosol generating materials include at least one gelling agent selected from alginates, pectins, hydroxyethyl cellulose, hydroxypropyl cellulose, carboxymethylcellulose, pullulan, xanthan gum guar gum, carrageenan, agarose, acacia gum, fumed silica, PDMS, sodium silicate, kaolin and polyvinyl alcohol. Such gelling agents may be used in combination with appropriate setting (e.g. cross-linking) agents. For example, alginates and/or pectins may be crosslinked by calcium ions. In certain embodiments of the invention, the gelling agent may be at least one alginate and/or at least one pectin crosslinked by calcium ions.

An example of gelling agents which may be used in forming an aerosol generating material are alginate salts. Alginate salts are polysaccharides derived from alginic acid and are typically high molecular weight polymers (10-600 kDa). Alginic acid is a copolymer of β-D-mannuronic (M) and α-L-guluronic acid (G) units (blocks) linked together with (1,4)-glycosidic bonds. On addition of calcium cations, the alginate crosslinks to form a gel. In some embodiments, the gelling agent may comprise or consist of an alginate salt in which at least about 40%, 45%, 50%, 55%, 60% or 70% of the monomer units in the alginate copolymer are α-L-guluronic acid (G) units. Where the gelling agent comprises at least one alginate, a setting agent comprising calcium ions may be used. Gels comprising alginates may be dried to for films of aerosol generating material. Such films may be in the form of amorphous solids as described herein.

Aerosol generating materials may comprise an active constituent. Suitable active constituents include those described herein. Examples of such active constituents include tobacco, tobacco material (e.g. tobacco extract) and/or nicotine. Nicotine may be present in the aerosol generating materials, with or without the presence of tobacco or tobacco extract.

Aerosol generating materials may comprise a flavouring constituent. Suitable flavouring constituents include those described herein. The flavour may, for example, comprise one or more mint-flavours, suitably a mint oil from any species of the genus Mentha. The flavour may suitably comprise, consist essentially of or consist of menthol. Other flavours may be used, including those disclosed herein.

In certain embodiments, the consumable may comprise at least two different compositions of aerosol generating materials. Where this is the case, each aerosol generating material may be different from other compositions present by at least one difference selected from; comprising a different flavour, comprising a different total content of flavour, comprising a different concentration of flavour, comprising a different active constituent, comprising a different total content of active constituent, comprising a different concentration of active constituent and any combination of such differences.

In certain embodiments, the consumable may comprise at least two different compositions of aerosol generating materials. Where this is the case, the discrete portions of each aerosol generating material composition may be distinguished by at least one visual difference. For example, each composition of aerosol generating material may be shaped or coloured in a manner distinctive to that composition or that portion. This may be an arbitrary shape or colour or one chosen to be suggestive of the flavour, active ingredient, active ingredient content or heating duration of that composition or portion. Thus, the shape and/or colour of a discrete portion may be indicative of the composition or amount of aerosol generating material in that portion.

In certain embodiments, the consumable may comprise a support formed of at least one support material having at least one surface wherein an aerosol generating material, such as an aerosol generating gel, is deposited on one or more portions or “regions” of said surface. In certain embodiments, the region or regions of said surface upon which the aerosol generating material is present may each be surrounded by a portion of said surface having no aerosol generating material present. Thus, the or each portion or region of said surface upon which aerosol generating material is present may be surrounded or “framed” by a region where aerosol generating material is absent or substantially absent. Each region of aerosol generating material may thus form a discrete portion of aerosol generating material.

In certain embodiments, the consumable may comprise a support formed of at least one support material having at least one surface wherein an aerosol generating material, such as an aerosol generating gel or film, is deposited on one or more portions or “regions” of said surface and optionally dried. In certain embodiments, a plurality of regions of aerosol generating material will be present on said surface.

In certain embodiments, at least two different aerosol generating materials will be present, each aerosol generating material being present in at least one region separate from any region containing other aerosol generating material(s). Thus, at least two aerosol generating materials having different compositions may be present as different discrete portions of aerosol generating material. Each separate composition of aerosol generating material may be present in more than one discrete portion (e.g. in different regions of a surface).

Where more than one composition of aerosol generating material is present and each composition is present in more than one discrete portion, each composition of aerosol generating material may be arranged in a regular or systematic arrangement of portions. Such arrangements may include strips, blocks or regions of a single composition or alternating or sequential arrangements of different compositions in one or two dimensions.

In certain embodiments, the consumable may comprise a support formed of at least one support material having at least one surface wherein an aerosol generating material, such as an aerosol generating gel or film, is deposited on one or more portions or “regions” of said surface. In certain embodiments, the shape of the regions upon which aerosol generating material is present may be controlled. In certain embodiments, each region will be the same or substantially the same shape and size as the other regions. In an alternative embodiment, the regions of aerosol generating material may be of different sizes. This may allow a choice of user experience by selective heating of specific regions.

In one embodiment, the support may be substantially planar in overall shape. In such a configuration, the aerosol generating material or portions thereof may be substantially in a single plane or in parallel planes (e.g. on top and bottom surfaces). Thus, in one embodiment, the consumable may be generally flat, having at least one top surface and at least one bottom surface, surrounded by at least one edge. Such surfaces may be raised, embossed, creased and/or corrugated (e.g. as described in various embodiments herein), in part or as a whole, while maintaining any overall shape or configuration including a flat configuration. A consumable having a flat configuration will typically be formed from a support (which may comprise multiple layers such as described herein) in the form of one or more sheets of material. Suitable materials include at least one of those described herein such as polymers (e.g. materials from natural polymers such as paper or card or synthetic polymer films) and/or metal foils. In use, flat consumables may be used in a flat configuration or may be folded or rolled (e.g. by the user) prior to use.

In an alternative embodiment, the support may be a substantially 3-dimensional overall shape. In such a configuration, the aerosol generating material, or portions thereof, may be present in arrangements that are not in a single plane or in parallel planes. In one embodiment, the consumable may be in the form of a tube or cone. Such a tube or cone may have any suitable cross-section, such as regular or irregular polygonal cross-section such as a circular, square, rectangular, pentagonal, hexagonal or stellar cross-section.

In one embodiment, the consumable may be a generally tubular configuration, such as a tube of circular cross-section. Such a tubular consumable may comprise a support having a tubular configuration with an inside surface and an outside surface. In one embodiment, the aerosol generating material, such as the discrete portions of aerosol generating material, may be supported on the outside surface of the support. In such a configuration, the protection element may be in the form of a sheet which wraps around the consumable.

In an alternative embodiment, applicable to consumables of any configuration, the protection element may be in the form of at least two pieces such as sheets (e.g. 2 to 20 pieces) where each piece is independently removable or can be removed without removing all other pieces (e.g. the pieces may be removed sequentially such as where pieces are partially overlapping).

In certain embodiments, the overall shape and dimensions of the consumable item will be selected to correspond to the appropriate portion of at least one design of heating device. Thus, the consumable may be adapted to removably fit on, into and/or around at least one portion of at least one heating device. In certain embodiments, the overall outer shape (outer perimeter) of the consumable may be, or substantially be, a regular polygon or other shape with rotational symmetry. This may allow the consumable to be positioned on, in, against and/or around the heating device in a plurality of orientations, which may allow selective heating of certain portions or regions of aerosol generating material.

In certain embodiments, the overall outer perimeter of the consumable may be circular, or substantially circular, in at least one dimension. In certain embodiments, the overall outer shape of the consumable may have a circular or substantially circular cross-section in at least one plane.

In certain embodiments, the overall outer perimeter of the consumable may be non-circular, (and not substantially circular). In certain embodiments, the overall outer shape of the consumable may have a non-circular cross-section. Examples of non-circular outer perimeters include substantially square or rectangular outer perimeters.

In certain embodiments the aerosol generating material, for example the aerosol generating gel or film, will be in discrete portions or “dots”. In use, such dots may be heated individually or in sets or groups. Such selective partial heating of the aerosol generating material may allow for control over the type and/or amount of aerosol generated and/or the duration of that generation. Each dot may be present on a discrete region of the support material, as described herein.

In appropriate embodiments, dots of aerosol generating material and/or their corresponding regions of a surface of a support material may be any suitable shape. In certain embodiments, the dots may be substantially circular and may be positioned in a grid or hexagonal packing arrangement. In an alternative embodiment, the dots may be of a shape that can tessellate to cover at least a portion of a surface of a support material, optionally allowing for a “bare” region of said surface between dots, as described herein. Suitable non-circular dots may be square, rectangular or hexagonal in shape, allowing for grid or hexagonal packing of dots over a surface of the support. Other tessellating or substantially tessellating shapes may also be suitable.

Where the aerosol generating material is present in discrete portions, each portion may be any appropriate dimension, mass and/or volume. Typical portions may be, for example, 0.1 to 100 mg (e.g. 1 to 100 mg) of aerosol generating material, such as 1 to 50 or 2 to 25 mg per portion. The aerosol generating material may have any suitable area density, such as from 30 g/m² to 120 g/m². In some embodiments, aerosol generating material may have an area density of from about 30 to 70 g/m², or about 40 to 60 g/m². In some embodiments, the aerosol-generating material may have an area density of from about 80 to 120 g/m², or from about 70 to 110 g/m², or particularly from about 90 to 110 g/m².

Suitably, the thickness of the aerosol generating material may be in the range of about 0.05 mm, 0.1 mm or 0.15 mm to about 0.5 mm or 0.3 mm. The inventors have found that a material having a thickness of around 0.2 mm (e.g. 0.18 to 0.22 mm) is particularly suitable.

Typical portions may be, for example, 5 mm to 10 cm in largest dimension, such as from around 5 mm, 8 mm or 10 mm, to around 15 mm, 20 mm or 30 mm in largest dimension. Around 13 mm (e.g. 10 to 15 mm) is highly suitable. In certain embodiments, the area of a portion may be between 50 and 200 mm². This may suitably be between 125 and 150 mm² (e.g. around 140 mm², such as 135-145 mm²) or between 60 and 81 mm². In some embodiments, an aerosol generating material is attached to a first surface of a support layer and the aerosol generating material is treated with an anti-adhesive agent on at least one surface not attached to said support layer.

As an example, the anti-adhesive agent may comprise minerals such as talc or calcium carbonate, celluloses, starches, lecithin, silicone and/or polytetrafluoroethylene (PTFE) and the like. The anti-adhesive agent is stable (i.e. does not melt, decompose etc.) at the operating temperatures of the assemblies described herein. In an embodiment, the anti-adhesive agent may be talcum powder, powdered calcium carbonate or another powder that may be applied to the surface of the amorphous solid, and which may cover any tackiness and help to prevent adhesion.

In some cases, the consumable may be manufactured in the form of a sheet, which may optionally be held in wound or coiled form, for example during manufacture before cutting into appropriate sizes for final use. The amorphous aerosol generating material described herein, particularly those formed from a gel (optionally by drying a gel to generate a film) may have tacky surfaces which complicates the handling. Through selecting a combination of aerosol generating material, support layer(s) and optionally the anti-adhesive agent, the aerosol generating material may be prevented from adhering to the reverse surface of the support or backing, thereby improving the handleability during manufacture.

In some cases, the consumable may comprise one or more magnets which can be used to fasten the consumable to a heater (e.g. an induction heater) in use.

In certain embodiments, the consumable item may comprise a support layer as at least a part of the support, in at least partial contact with the aerosol generating material. Such a support layer may be formed of any suitable material including metal, or polymer materials including bio-polymer materials such as cellulose. In certain embodiments, the support layer may be a metal foil such as aluminium foil. Where a support layer is formed of aluminium, the aluminium may have a thickness of between 5 μm to 25 μm. The aluminium thickness may be 7 μm, 10 μm or 20 μm and may be between 6 μm and 8 μm. Metal support layers have the advantage of high thermal conductivity and may act as heaters due to the electrical resistance of the material by passing a current through at least a part of the support layer. Such a current may be generated by a conventional electrical circuit or by electrical induction. In one embodiment, a metal film forming a support layer acts as susceptor for electrical inductive heating of at least a portion of the consumable.

In certain embodiments the support may comprise a support layer, such as a metal foil support layer, and may further comprise a backing layer of a similar of different material. In certain embodiments, the support may comprise a backing layer of a polymer material such as a bio-polymer or synthetic polymer material. Suitable biopolymer materials include polysaccharides including cellulose-based materials such as paper or card. Synthetic polymer materials should have a melting point sufficiently high to retain structural integrity at temperatures employed to heat the aerosol generating material. Such polymers may thus have a melting point above 200° C. or above 250° C. Suitable examples include polyaryletherketones (PAEKs) such as polyether ether ketone (PEEK).

In certain embodiments, the reverse of the support of a first consumable may form the protection element of a second consumable. This applies particular to consumables with a flat configuration. In such an embodiment, an opposite surface, being the surface of the support opposing that surface supporting the (portions of) aerosol generating material, in the first consumable may act as the protection element for the second consumable. In such embodiments, at least a portion of the opposite surface of the first consumable may be removably affixed to the or each fixing zone of the second consumable. This allows for the consumables to form a “stack” in which the opposite surface of each consumable acts as the protection element for the next. An additional protection element, such as any of those described herein, may be provided for the first consumable.

In certain embodiments, the discrete portions of aerosol generating material may be supported on a planar support such as a planar foil support layer and an optional planar backing layer. In appropriate embodiments, the aerosol generating material (e.g. all discrete portions of aerosol generating material) will be supported on a single surface of the support.

In alternative embodiments, the discrete portions of aerosol generating material may be supported within indentations or depressions in the support. In certain embodiments, each discrete portion of aerosol generating material may be present in an individual depression in the support surface. Such depressions may be substantially round in the plane of the surface of the support.

Alternatively, such depressions may be a tessellating shape and may be substantially square, substantially rectangular or substantially hexagonal in the plane of the surface of the support and may be arranged in any appropriate arrangement, such as a grid or hexagonal packing arrangement. Optionally a fixing zone may be present between depressions. Such a fixing zone may be present between each depression or between certain groups or sets of depressions. In certain embodiments, the aerosol generating material may substantially fill the depressions up to the level of the plane of the support surface. In certain embodiments, the volume of the portions of aerosol generating material may be less than 100% of the capacity of the depressions, such as 50% to 99% or 80% to 90% of that capacity.

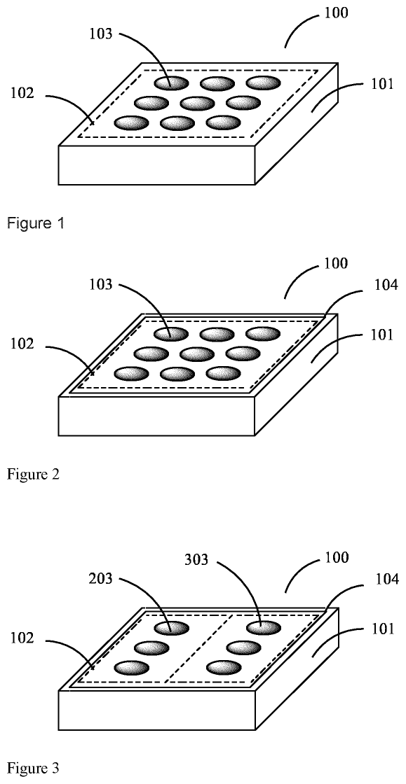

Referring to FIGS. 1 to 2, there is shown a consumable 100 for use with a non-combustible aerosol provision device. The consumable 100 includes a support 101, fixing zone 102 and discrete portions of aerosol generating material 103. The embodiment shown has a removable protection element, which has been removed in this figure. FIG. 2 represents the consumable of FIG. 1 with the removable protection element 104 in place. It can be seen that the fixing zones 102 define a region inclosing all discrete portions of aerosol generating material and thus the protection element serves to protect all such portions 103. The portions 103 may all be of the same aerosol generating material composition or may differ in content such as in active or flavouring agent.

Previous consumables, particularly those comprising gel or dried gel aerosol generating materials have been known to be or become adherent to each other and to other surfaces. The presence of a protection element protecting all portions of aerosol generating material serves to reduce or mitigate this issue.

FIG. 3 represents an alternative consumable in which fixing zone 102 extends between certain portions of the aerosol generating material. In this embodiment, two areas of aerosol generating material portions 203 and 303 are demarcated by the fixing zones. Where two areas are separated in this way, these areas may represent aerosol generating materials with differing compositions. The fixing zones present between areas of different composition may additionally server to reduce cross-contamination of, for example, the flavour of one zone into a neighbouring zone. The protection element may thus additionally serve to protect the distinction between the aerosol generating material compositions where the compositions of portions 203 and 303 differ in flavour.

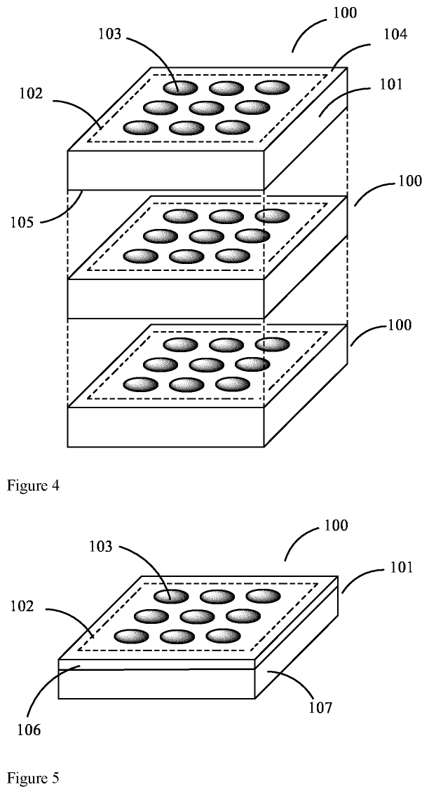

Referring to FIG. 4 it can be seen that in some cases opposing surface 105 of a consumable 100 may act as protection element for another consumable 100. This may serve to aid packing, transportation and/or manufacture since multiple consumables 100 may be packed together without requiring a separate protection layer. The upper-most consumable may have a removable or partially removable protection element. Such a protection element may be integrated into or attached to a packaging element such that the act of unpacking the uppermost consumable for use may serve to remove the upper protection element.

FIG. 5 represents a consumable having a support comprising two layers. The layer 106 serving to support the aerosol generating material portions may be, for example, a metal sheet such as an aluminium foil layer. Such a foil layer may additionally act as a susceptor for inductive heating. A second layer on the opposing surface may be a backing layer of a polymer based material such as paper or card. This may provide additional structural stability to the consumable.

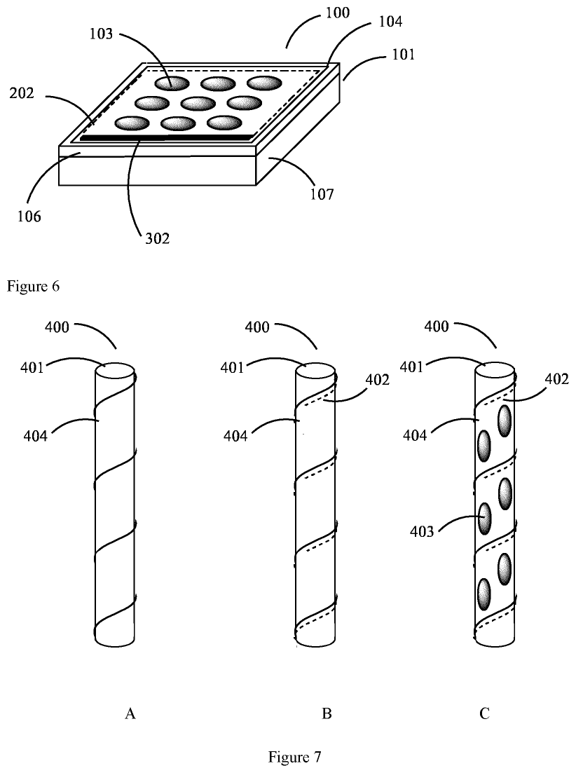

FIG. 6 represents the consumable of FIG. 5 with the protection element 104 in place. In this embodiment, the protection element 104 is fixed partially removably to the support 101. Two fixing zones 202 and 302 are provided such that protection element 104 is fixed removably on three sides by fixing zone 202 and substantially irremovably on the third side by fixing zone 302. If the protection element is, for example, a sheet, this may be partially removed and tucked under the consumable before use to avoid generation of a separate waste element.

FIG. 7 represents a consumable 400 in a tubular configuration. In this embodiment the support is in the form of a tube 401 having a protection element 404 in the form of a ribbon wrapped around the consumable. FIG. 7A shows the consumable having an opaque protection element (e.g. a coated paper protection element). FIG. 7B additionally shows the fixing zone 402 which in this case is in the form of a spiral, following the protection element around the tubular support. FIG. 7C shows the same consumable with a transparent protection element (such as a transparent polymer) such that discrete portions of Aerosol Generating material 403 can be seen. Since the protective element is in the form of a ribbon, wound around the consumable, the protective element may be partially unwound allowing the consumable to be partially used while continuing to protect the remaining portions of aerosol generating material.

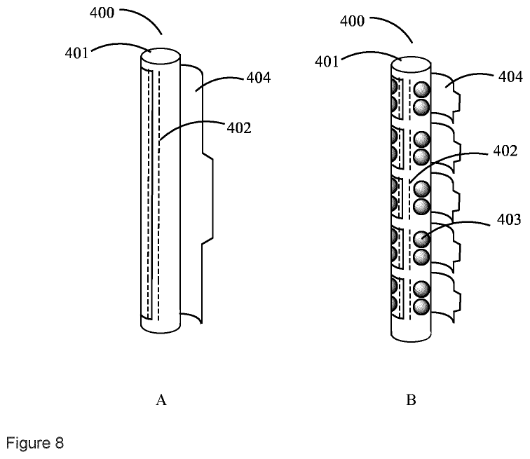

FIG. 8 represents a consumable 400 in tubular configuration. 8A shows a consumable with a single protective element while 8B shows a similar consumable with 5 independent protective elements. FIG. 8 is illustrated with the protective element sheet(s) 404 partially unwrapped. Fixing zones 402 can be seen such that in the partially unwrapped state the protective element(s) is attached to one fixing zone but has been removed from another. In FIG. 8B, five independent protective elements are present each protecting portions of aerosol generating material 403. Since each protective element can be removed independently, the consumable may be partially used while used while continuing to protect the remaining portions of aerosol generating material.

The examples above illustrate the invention using embodiments with an aerosol generating material on a first surface of a support. However, in other examples the support may include depressions in which the discrete portions of aerosol generating material may be contained. This arrangement enables a more planar protection element which may be easier to manufacture and may be more readily punctured as an alternative to removal.

The various embodiments described herein are presented only to assist in understanding and teaching the claimed features. These embodiments are provided as a representative sample of embodiments only, and are not exhaustive and/or exclusive. It is to be understood that advantages, embodiments, examples, functions, features, structures, and/or other aspects described herein are not to be considered limitations on the scope of the invention as defined by the claims or limitations on equivalents to the claims, and that other embodiments may be utilised and modifications may be made without departing from the scope of the claimed invention. Various embodiments of the invention may suitably comprise, consist of, or consist essentially of, appropriate combinations of the disclosed elements, components, features, parts, steps, means, etc, other than those specifically described herein. In addition, this disclosure may include other inventions not presently claimed, but which may be claimed in future.

### Definitions

According to the present disclosure, a “non-combustible” aerosol provision system is one where a constituent aerosol-generating material of the aerosol provision system (or component thereof) is not combusted or burned in order to facilitate delivery of at least one substance to a user.

In some embodiments, the non-combustible aerosol provision system is an electronic cigarette, also known as a vaping device or electronic nicotine delivery system (END), although it is noted that the presence of nicotine in the aerosol-generating material is not a requirement.

In some embodiments, the non-combustible aerosol provision system is an aerosol-generating material heating system, also known as a heat-not-burn system. An example of such a system is a tobacco heating system.

Typically, the non-combustible aerosol provision system may comprise a non-combustible aerosol provision device and a consumable, such as those disclosed herein, for use with the non-combustible aerosol provision device.

In some embodiments, the disclosure relates to consumables comprising aerosol-generating material and configured to be used with non-combustible aerosol provision devices.

In some embodiments, the non-combustible aerosol provision system, such as a non-combustible aerosol provision device thereof, may comprise a power source and a controller. The power source may, for example, be an electric power source or an exothermic power source. In some embodiments, the exothermic power source comprises a carbon substrate which may be energised so as to distribute power in the form of heat to an aerosol-generating material or to a heat transfer material in proximity to the exothermic power source.

In some embodiments, the non-combustible aerosol provision system may comprise an area for receiving the consumable, an aerosol generator, an aerosol generation area, a housing, a mouthpiece, a filter and/or an aerosol-modifying agent.

In some embodiments, the consumable for use with the non-combustible aerosol provision device may, where technically compatible, comprise aerosol-generating material, an aerosol-generating material storage area, an aerosol-generating material transfer component, an aerosol generator, an aerosol generation area, a housing, a wrapper, a filter, a mouthpiece, and/or an aerosol-modifying agent.

The active constituent as used herein may be a physiologically active material, which is a material intended to achieve or enhance a physiological response. The active constituent may for example be selected from nutraceuticals, nootropics, psychoactives. The active constituent may be naturally occurring or synthetically obtained. The active constituent may comprise for example nicotine, caffeine, taurine, theine, vitamins such as B6 or B12 or C, melatonin, or combinations thereof. The active constituent may comprise one or more constituents, derivatives or extracts of tobacco, another botanical. In one embodiment the botanical may be cannabis and/or the active constituent may be cannabinoids, or constituents or derivatives thereof, optionally in combination with other physiologically active agents.

In some embodiments, the active constituent comprises nicotine.

In some embodiments, the active constituent comprises caffeine, melatonin or vitamin B12.

As noted herein, the active constituent may comprise one or more constituents, derivatives or extracts of cannabis, such as one or more cannabinoids or terpenes.

Cannabinoids are a class of natural or synthetic chemical compounds which act on cannabinoid receptors (i.e., CB1 and CB2) in cells that repress neurotransmitter release in the brain. Cannabinoids may be naturally occurring (phytocannabinoids) from plants such as cannabis, from animals (endocannabinoids), or artificially manufactured (synthetic cannabinoids). Cannabis species express at least 85 different phytocannabinoids, and are divided into subclasses, including cannabigerols, cannabichromenes, cannabidiols, tetrahydrocannabinols, cannabinols and cannabinodiols, and other cannabinoids. Cannabinoids found in cannabis include, without limitation: cannabigerol (CBG), cannabichromene (CBC), cannabidiol (CBD), tetrahydrocannabinol (THC), cannabinol (CBN), cannabinodiol (CBDL), cannabicyclol (CBL), cannabivarin (CBV), tetrahydrocannabivarin (THCV), cannabidivarin (CBDV), cannabichromevarin (CBCV), cannabigerovarin (CBGV), cannabigerol monomethyl ether (CBGM), cannabinerolic acid, cannabidiolic acid (CBDA), Cannabinol propyl variant (CBNV), cannabitriol (CBO), tetrahydrocannabmolic acid (THCA), and tetrahydrocannabivarinic acid (THCV A).

As noted herein, the active constituent may comprise or be derived from one or more botanicals or constituents, derivatives or extracts thereof. As used herein, the term “botanical” includes any material derived from plants including, but not limited to, extracts, leaves, bark, fibres, stems, roots, seeds, flowers, fruits, pollen, husk, shells or the like. Alternatively, the material may comprise an active compound naturally existing in a botanical, obtained synthetically. The material may be in the form of liquid, gas, solid, powder, dust, crushed consumables, granules, pellets, shreds, strips, sheets, or the like. Example botanicals are tobacco, eucalyptus, star anise, hemp, cocoa, fennel, lemongrass, peppermint, spearmint, rooibos, chamomile, flax, ginger, Ginkgo biloba, hazel, hibiscus, laurel, licorice (liquorice), matcha, mate, orange skin, papaya, rose, sage, tea such as green tea or black tea, thyme, clove, cinnamon, coffee, aniseed (anise), basil, bay leaves, cardamom, coriander, cumin, nutmeg, oregano, paprika, rosemary, saffron, lavender, lemon peel, mint, juniper, elderflower, vanilla, wintergreen, beefsteak plant, curcuma, turmeric, sandalwood, cilantro, bergamot, orange blossom, myrtle, cassis, valerian, pimento, mace, damien, marjoram, olive, lemon balm, lemon basil, chive, carvi, verbena, tarragon, geranium, mulberry, ginseng, theanine, theacrine, maca, ashwagandha, damiana, guarana, chlorophyll, baobab or any combination thereof. Cannabis forms a further botanical which may be used alone or in combination with at least one other.

Where present, the mint may be chosen from the following mint varieties: Mentha arvensis, Mentha c.v., Mentha niliaca, Mentha piperita, Mentha piperita citrata c.v., Mentha piperita c.v., Mentha spicata crispa, Mentha cordifolia, Mentha longifolia, Mentha suaveolens variegata, Mentha pulegium, Mentha spicata c.v. and Mentha suaveolens.

In some embodiments, the botanical is selected from eucalyptus, star anise, cocoa and hemp.

In some embodiments, the botanical is selected from rooibos and fennel.

As used herein, the terms “flavour” and “flavourant” refer to materials which, where local regulations permit, may be used to create a desired taste, aroma or other somatosensorial sensation in a product for adult consumers. They may include naturally occurring flavour materials, botanicals, extracts of botanicals, synthetically obtained materials, or combinations thereof (e.g., tobacco, cannabis, licorice (liquorice), hydrangea, eugenol, Japanese white bark magnolia leaf, chamomile, fenugreek, clove, maple, matcha, menthol, Japanese mint, aniseed (anise), cinnamon, turmeric, Indian spices, Asian spices, herb, wintergreen, cherry, berry, red berry, cranberry, peach, apple, orange, mango, clementine, lemon, lime, tropical fruit, papaya, rhubarb, grape, durian, dragon fruit, cucumber, blueberry, mulberry, citrus fruits, Drambuie, bourbon, scotch, whiskey, gin, tequila, rum, spearmint, peppermint, lavender, aloe vera, cardamom, celery, cascarilla, nutmeg, sandalwood, bergamot, geranium, khat, naswar, betel, shisha, pine, honey essence, rose oil, vanilla, lemon oil, orange oil, orange blossom, cherry blossom, cassia, caraway, cognac, jasmine, ylang-ylang, sage, fennel, wasabi, piment, ginger, coriander, coffee, hemp, a mint oil from any species of the genus Mentha, eucalyptus, star anise, cocoa, lemongrass, rooibos, flax, Ginkgo biloba, hazel, hibiscus, laurel, mate, orange skin, rose, tea such as green tea or black tea, thyme, juniper, elderflower, basil, bay leaves, cumin, oregano, paprika, rosemary, saffron, lemon peel, mint, beefsteak plant, curcuma, cilantro, myrtle, cassis, valerian, pimento, mace, damien, marjoram, olive, lemon balm, lemon basil, chive, carvi, verbena, tarragon, limonene, thymol, camphene), flavour enhancers, bitterness receptor site blockers, sensorial receptor site activators or stimulators, sugars and/or sugar substitutes (e.g., sucralose, acesulfame potassium, aspartame, saccharine, cyclamates, lactose, sucrose, glucose, fructose, sorbitol, or mannitol), and other additives such as charcoal, chlorophyll, minerals, botanicals, or breath freshening agents. They may be imitation, synthetic or natural ingredients or blends thereof. They may be in any suitable form, for example, liquid such as an oil, solid such as a powder, or gas.

The flavour may suitably comprise one or more mint-flavours suitably a mint oil from any species of the genus Mentha. The flavour may suitably comprise, consist essentially of or consist of menthol.

In some embodiments, the flavour comprises menthol, spearmint and/or peppermint.

In some embodiments, the flavour comprises flavour components of cucumber, blueberry, citrus fruits and/or redberry.

In some embodiments, the flavour comprises eugenol.

In some embodiments, the flavour comprises flavour components extracted from tobacco.

In some embodiments, the flavour comprises flavour components extracted from cannabis.

In some embodiments, the flavour may comprise a sensate, which is intended to achieve a somatosensorial sensation which are usually chemically induced and perceived by the stimulation of the fifth cranial nerve (trigeminal nerve), in addition to or in place of aroma or taste nerves, and these may include agents providing heating, cooling, tingling, numbing effect. A suitable heat effect agent may be, but is not limited to, vanillyl ethyl ether and a suitable cooling agent may be, but not limited to eucalyptol, WS-3.

As used herein, the term “aerosol forming material” refers to an agent that promotes the generation of an aerosol. An aerosol forming material may promote the generation of an aerosol by promoting an initial vaporisation and/or the condensation of a gas to an inhalable solid and/or liquid aerosol.

Suitable aerosol forming materials include, but are not limited to: a polyol such as erythritol, sorbitol, glycerol, and glycols like propylene glycol or triethylene glycol; a non-polyol such as monohydric alcohols, high boiling point hydrocarbons, acids such as lactic acid, glycerol derivatives, esters such as diacetin, triacetin, triethylene glycol diacetate, triethyl citrate or myristates including ethyl myristate and isopropyl myristate and aliphatic carboxylic acid esters such as methyl stearate, dimethyl dodecanedioate and dimethyl tetradecanedioate. The aerosol forming material may suitably have a composition that does not dissolve menthol. The aerosol forming material may suitably comprise, consist essentially of or consist of glycerol.

As used herein, the term “tobacco material” refers to any material comprising tobacco or derivatives thereof. The term “tobacco material” may include one or more of tobacco, tobacco derivatives, expanded tobacco, reconstituted tobacco or tobacco substitutes. The tobacco material may comprise one or more of ground tobacco, tobacco fibre, cut tobacco, extruded tobacco, tobacco stem, reconstituted tobacco and/or tobacco extract.

The tobacco used to produce tobacco material may be any suitable tobacco, such as single grades or blends, cut rag or whole leaf, including Virginia and/or Burley and/or Oriental. It may also be tobacco consumable ‘fines’ or dust, expanded tobacco, stems, expanded stems, and other processed stem materials, such as cut rolled stems. The tobacco material may be a ground tobacco or a reconstituted tobacco material. The reconstituted tobacco material may comprise tobacco fibres, and may be formed by casting, a Fourdrinier-based paper making-type approach with back addition of tobacco extract, or by extrusion.

All percentages by weight described herein (denoted wt %) are calculated on a dry weight basis, unless explicitly stated otherwise. All weight ratios are also calculated on a dry weight basis. A weight quoted on a dry weight basis refers to the whole of the extract or slurry or material, other than the water, and may include components which by themselves are liquid at room temperature and pressure, such as glycerol. Conversely, a weight percentage quoted on a wet weight basis refers to all components, including water.

When a material, such as a gel, is referred to herein as “dried” this indicates that the material is at least functionally dry such that it does not flow as a fluid. Dried may indicate that substantially all of the water is removed but in many cases a certain amount may remain and thus a material may be dried and contain less than 10% water (e.g. 0.01 to 10%), preferably less than 5%, more preferably less than 1% water by weight. Partially dried may indicate, for example, that at least half of the initial water content is removed.

For the avoidance of doubt, where in this specification the term “comprises” is used in defining the invention or features of the invention, embodiments are also disclosed in which the invention or feature can be defined using the terms “consists essentially of” or “consists of” in place of “comprises”. Reference to a material “comprising” certain features means that those features are included in, contained in, or held within the material.

The above embodiments are to be understood as illustrative examples of the invention. It is to be understood that any feature described in relation to any one embodiment may be used alone, or in combination with other features described, and may also be used in combination with one or more features of any other of the embodiments, or any combination of any other of the embodiments. Furthermore, equivalents and modifications not described above may also be employed without departing from the scope of the invention, which is defined in the accompanying claims.

1. A consumable for use with a non-combustible aerosol provision device, the consumable comprising a support, aerosol generating material, and a protection element wherein;
the aerosol generating material is at least partially supported on at least one surface of the support;
the support comprises at least one surface and at least one fixing zone;
the or each fixing zone is located on one or more surface of the support;
the area extending between the outermost edges of the or each fixing zone includes at least a portion of the aerosol generating material; and
the protection element is affixed to at least one fixing zone.

2. The consumable of claim 1 wherein the aerosol generating material comprises two or more discrete portions of aerosol generating material;

3. The consumable of claim 1 wherein the protection element is at least partially removable.

4. The consumable of claim 1 wherein the protection element is pierceable.

5. The consumable of claim 1 wherein the protection element is in the form of a flat or corrugated sheet or ribbon.

6. (canceled)

7. The consumable of claim 1 wherein the protection element to does not adhere, or releasably adheres to the aerosol generating material.

8. The consumable of claim 1 wherein the protection element is formed from a polymer material such as a biopolymer or an alginate polymer such as a calcium alginate.

9. (canceled)

10. The consumable of claim 1 wherein the support comprises a susceptor.

11. The consumable of claim 10 wherein the susceptor comprises a sheet material such as a metal foil.

12. The consumable of claim 1 wherein the support comprises a support layer and a backing layer, wherein the support layer forms at least one surface upon which at least a portion of the aerosol generating material is supported.

13. The consumable of claim 12 wherein the support layer forms a susceptor.

14. The consumable of claim 12 wherein the backing layer is formed from a polymer material such as paper, card or a polyaryletherketone.

15. (canceled)

16. (canceled)

17. The consumable of claim 1 wherein there is one fixing zone and the outermost edge of the fixing zone surrounds all portions of the aerosol generating material or wherein there are two or more discrete fixing zones and the area extending between the edges of the outer-most fixing zones includes all portions of the aerosol generating material.

18. The consumable of claim 1 wherein the aerosol generating material is in at least two discrete portions and wherein a fixing zone extends between some of the discrete portions.

19. (canceled)

20. (canceled)

21. The consumable of claim 1 wherein all portions of the aerosol generating material are supported on one surface of the support and wherein the support is substantially planar and all portions of the aerosol generating material are supported substantially in one plane or wherein the support is substantially tubular and all portions of the aerosol generating material are supported on the inside surface and/or the outside surface of the tube.

22. The consumable of claim 1 having discrete portions of the aerosol generating material which are each supported in a depression in the surface of the support.

23. (canceled)

24. (canceled)

25. (canceled)

26. (canceled)

27. The consumable of claim 1 having two or more discrete portions of aerosol generating material wherein at least two discrete portions of the aerosol generating material have different compositions from each other.

28. (canceled)

29. The consumable of claim 27 wherein each discrete portion is of a shape and/or colour that is indicative of the composition of the aerosol generating material forming the discrete portion.

30. A non-combustible aerosol provision system comprising a non-combustible aerosol provision device; and a consumable for use with the a non-combustible aerosol provision device, where the consumable is as defined in claim 1.

31. A kit comprising a non-combustible aerosol provision device; and a consumable for use with the a non-combustible aerosol provision device, wherein the consumable is as defined in claim 1.

32. A method of manufacturing a consumable for use with a non-combustible aerosol provision device, the method comprising providing a support having at least one surface and at least one fixing zone, providing an aerosol generating material, optionally in at least two discrete portions, on at least one surface of said support and affixing a protection element to the at least one fixing zone such that the area extending between the outmost edges of the or each fixing zone includes at least a portion of the aerosol generating material.
